(19) United States
(12) Patent Application Publication
(10) Pub. No.: US 2023/0311309 A1
(43) Pub. Date: Oct. 5, 2023

(54) METHOD AND SYSTEM FOR DETERMINING OPTIMIZED PROGRAM PARAMETERS FOR A ROBOT PROGRAM

(71) Applicant: ArtiMinds Robotics GmbH, Karlsruhe (DE)

(72) Inventors: Rainer Jaekel, Ludwigsburg (DE); Darko Katic, Karlsruhe (DE); Benjamin Alt, Karlsruhe (DE)

(21) Appl. No.: 18/018,859

(22) PCT Filed: Jun. 4, 2021
(86) PCT No.: PCT/DE2021/200076

§ 371 Date: Jan. 30, 2023

(30) Foreign Application Priority Data
Jul. 28, 2020 (DE) 10 2020 209 511.6

(51) Int. Cl. B25J 9/16

(52) U.S. Cl. CPC B25J 9/163; B25J 9/161

(57) ABSTRACT

The invention relates to a method for determining optimized program parameters for a robot program, wherein the robot program is used to control a robot having a manipulator, preferably in a robot cell, comprising the steps: creating the robot program by means of a component-based graphical programming system on the basis of user inputs, wherein the robot program is formed from program components which are parameterizable via program parameters, and wherein initial program parameters are generated for the program components of the robot program; providing an interface for selecting one or more critical program components, wherein optimizable program parameters can be defined for the critical program components; carrying out an exploration phase for exploring a parameter range in relation to the optimizable program parameters, the robot program being carried out multiple times, the parameter range being scanned for the critical program components and trajectories of the robot being recorded such that training data are present for the critical program components; carrying out a learning phase in order to generate component representatives for the critical program components of the robot program on the basis of the training data collected in the exploration phase, wherein a component representative represents a system model which, in the form of a differentiable function, maps a specified state of the robot and specified program parameters to a predicted trajectory; carrying out an inference phase for determining optimized program parameters for the critical program components of the robot program, wherein optimizable program parameters of the component representative are iteratively optimized in respect of a specified target function by means of a gradient-based optimization method using the component representative. The invention furthermore relates to a corresponding system.

The invention relates to a method for determining optimized program parameters for a robot program, the robot program being used to control a robot having a manipulator, preferably in a robot cell.

Methods and systems for determining program parameters for a robot program have been known in practice for some years. These refer to the programming of a robot, wherein suitable program parameters usually need to be selected manually for the corresponding robot program.

In manufacturing industry, industrial robots are used in particular for accomplishing complex manipulation and assembly tasks as well as for surface treatment, if the workpieces to be processed or the application tasks to be carried out have a degree of variability. The ability of industrial robot arms to access almost any tool or workpiece position and orientation within their working space, in combination with suitable end effectors, enables different application tasks to be accomplished or different workpiece variants to be processed within a robot cell.

Production cells with industrial robots are traditionally programmed using text, wherein for the initial parameterization, poses or partial movements are taught via teach-in procedures using so-called teach-pendants. Numerous manufacturer-specific and cross-manufacturer commercial products facilitate the offline programming of robot cells by the automatic generation of robot code and semi-automatic path generation based on CAD models of the robot cell and the workpieces to be processed (“CAD to Path”). Component-based programming system or programming software, such as the ArtiMinds Robot Programming Suite (RPS), RoboDK or drag&bot, simplify robot programming by encapsulating atomic motion primitives into abstract program components that can be combined into complex manipulation sequences.

Symbolic, parameterizable program representations are an established practice in service-based and industrial robotics. Task models usually consist of atomic, parameterizable action primitives, which can be combined by control-flow and logic primitives into complex action sequences and translated into sequences of specific robot movements. Generalized manipulation strategies and their implementation, such as the ArtiMinds Task Model, represent action primitives as groups of possibly learned constraints in the joint-angle or Cartesian space, from which movements are generated that satisfy these constraints. In this context, reference is made to German patent DE 10 2015 204 641 A1.

Other approaches generate abstract task plans from ontology-based knowledge databases or use explicit domain-specific languages (DSLs) to specify the problem to be solved and derive actions of the robot.

In industry, the optimization of program parameters is a predominantly manual process that requires expert knowledge. Various commercial products exist for the visual and quantitative support of this process, which after aggregation and statistical evaluation of the data of robots as well as external sensors and actuators, calculate process parameters and display the data suitably processed. Examples are the commercial software solution ArtiMinds Learning & Analytics for Robots (LAR), KUKA Connect, Siemens MindSphere, Bosch Nexeed or IXON. For example, with the Teach-Point Optimization (TPO) feature, ArtiMinds LAR enables the automatic adjustment of individual robot program parameters based on statistics derived from past program executions. Most robots in complex production plants are operated in external automatic mode and are automatically parameterized at runtime by programmable logic controllers, wherein the parameter sets are usually fixed per batch. Some platforms such as MindSphere or Nexeed allow the optimization and adaptation of certain parameters of the process controller to optimize parameters such as throughput or cycle time, but operate at the macro level, so that for example, fine-tuning of program parts of a robot program is not possible.

Since the behavior of a robot is specified in software, the development and maintenance effort of robot cells is relocated from the hardware into the software. A robust solution to complex manipulation tasks with industrial robots depends to a large extent on task-specific program parameters such as speeds, accelerations, force specifications or target points, which must be precisely matched to the task to be solved, the geometry and physical properties of the robot cell as well as the workpieces to be processed. Especially when commissioning new robot cells, fine-tuning of the program parameters is very time-consuming, requires highly specialized expert knowledge and delays the productive operation of the robot cell.

The object of the present invention is therefore to design and further develop a method and a system for determining optimized program parameters for a robot program of the type mentioned above, in such a way that the process of finding optimized program parameters for the robot program is simplified or improved.

The above object is achieved according to the invention by means of the features of claim 1. According to the claim, a method for determining optimized program parameters for a robot program is specified, wherein the robot program is used to control a robot having a manipulator, preferably in a robot cell, the method comprising the following steps:
generating the robot program by means of a component-based graphical programming system on the basis of user inputs, wherein the robot program is formed from program components which are parameterizable via program parameters, and wherein initial program parameters are generated for the program components of the robot program;
providing an interface for selecting one or more critical program components, wherein optimizable program parameters can be defined for the critical program components;
carrying out an exploration phase for exploring a parameter space in relation to the optimizable program parameters, the robot program being executed multiple times, the parameter space being sampled for the critical program components and trajectories of the robot being recorded such that training data are available for the critical program components;
carrying out a learning phase in order to generate component representatives for the critical program components of the robot program on the basis of the training data collected in the exploration phase, wherein a component representative represents a system model which, in the form of a differentiable function, maps a specified state of the robot and specified program parameters to a predicted trajectory;
carrying out an inference phase for determining optimized program parameters for the critical program components of the robot program, wherein optimizable program parameters of the component representatives are iteratively optimized with respect to a specified target function by means of a gradient-based optimization method using the component representatives.

The above object is additionally achieved by the features of claim 17. According to the claim, a system for determining optimized program parameters for a robot program is specified, the robot program being used to control a robot having a manipulator, preferably in a robot cell. This system comprises:
a component-based graphical programming system for generating a robot program on the basis of user inputs, wherein the robot program is formed from program components which are parameterizable via program parameters, and wherein initial program parameters can be generated for the program components of the robot program;
an interface for selecting one or more critical program components, wherein optimizable program parameters can be defined for the critical program components;
an exploration module for exploring a parameter space in relation to the optimizable program parameters, the robot program being executed multiple times, the parameter space being sampled for the critical program components, and trajectories of the robot being recorded such that training data are available for the critical program components;
a learning module for generating component representatives for the critical program components of the robot program on the basis of the training data collected in the exploration phase, wherein a component representative represents a system model which, in the form of a differentiable function, maps a specified state of the robot and specified program parameters to a predicted trajectory;
an inference module for determining optimized program parameters for the critical program components of the robot program, wherein optimizable program parameters of the component representatives are iteratively optimized with respect to a specified target function by means of a gradient-based optimization method using the component representatives.

According to the invention, it has first been recognized that it is quite a considerable advantage if program parameters that are optimized for a robot program or as optimal as possible for the respective application can be found in a maximally automated manner. In a further aspect of the invention, it has been recognized that a fine-tuning or fine adjustment of critical program parts of a robot program and their optimization with respect to application-specific target functions promises significant efficiency increases with regard to the programming, commissioning and/or maintenance phase of a robot. To define a program structure, a robot program is first created using a component-based graphical programming system based on user inputs. The robot program is formed from program components, wherein the program components can be parameterized via program parameters. The robot program therefore represents a semi-symbolic robot program. In addition, initial and thus preliminary program parameters for the program components of the robot program are generated or defined.

According to the invention, one or more critical program components can then be selected using a provided interface, wherein optimizable program parameters for the critical program components can be defined. In the course of an exploration phase, an automatic and stochastic exploration of a parameter space is carried out with regard to the optimizable program parameters. For this purpose, the robot program is executed multiple times or repeatedly, wherein an automatic sampling of the parameter space is carried out for the critical program components and resulting trajectories of the robot are recorded. Thus, training data can be collected for the critical program components at each execution of the robot program.

In the course of a subsequent learning phase, component representatives for the critical program modules of the robot program are generated, which uses the training data collected during the exploration phase. A component representative is a system model that, in the form of a differentiable function, maps a specified state of the robot measured or ascertained during the exploration phase and specified program parameters to a predicted—i.e. an expected—trajectory.

Finally, optimized program parameters for the critical program components of the robot program are determined in an inference phase. For this purpose, by means of a gradient-based optimization procedure using the previously generated component representatives, the optimizable program parameters of the component representatives are iteratively optimized with respect to a specified target function. For example, this results in an optimal parameter vector for each critical component. The optimized program parameters can be automatically transferred to the robot program. Thus, a robot program with optimum program parameters with respect to a specified target function can be achieved.

Consequently, using the method according to the invention for determining optimized program parameters for a robot program and using the system according to the invention, a simplified and improved process of finding optimized program parameters is possible.

A “component-based graphical programming system” can be understood—in particular in the context of the claims and preferably in the context of the description—as a programming system or a programming software that allows an encapsulation of atomic motion primitives into abstract program components, wherein the program components can be combined to form complex manipulation sequences. The ArtiMinds Robot Programming Suite (RPS), RoboDK or drag&bot are just some examples of possible component-based programming systems.

A “semi-symbolic robot program” can be understood—in particular in the context of the claims and preferably in the context of the description—as a robot program that has a symbolic structure (composed of individual program components), but the components of which (the program components) are variable in their behavior, because the exact behavior of the components also depends on the parameterization). Discrete program components, but which can each be parameterized, have both properties and can therefore be regarded as semi-symbolic. A component-based graphical programming system can generate a semi-symbolic robot program.

At this point it should be noted that a “program component”—in particular in the context of the claims and preferably in the context of the description—can be understood as the smallest unit of a symbolic or semi-symbolic robot program that can be configured by the user. The program component represents a predefined action of the robot. Program components can be combined sequentially into complex robot programs. Program components can be parameterized, i.e. they accept a vector of parameters, the values of which can be specified by the robot programmer when the robot program is created. Each program component has exactly one type that determines the action that the program component represents. Examples of program components are “Gripping”, “Point-to-point movement”, “Contact run (relative)”, “Arc run”, “Spiral search (relative)”, “Torque-controlled joining”, “Force-controlled pressing”, “Palletizing”, etc.

A “critical program component” can be understood—in particular within the context of the claims and preferably within the context of the description—as a program component for which optimized parameters are to be determined.

A “component representative” can be understood—in particular within the context of the claims and preferably within the context of the description—as a system model for a program component, which models the behavior of the program component during its execution. For example, in the context of the definition of a system model, a component representative can map a vector of input parameters and the system state present at the time of execution onto the trajectory to be expected during execution, wherein as part of the definition of a system model the system can include the robot arm and, if necessary, the environment of the robot and, if necessary, the objects manipulated during the execution of the program component.

A “system model” can be understood—in particular in the context of the claims and preferably in the context of the description—as a mathematical model which approximates the behavior of a system in a simplified way. For example, a “system model” can be defined as a mathematical function ƒ which outputs the expected trajectory I″ given the input parameters x and the system state p. ƒ therefore implicitly includes the program logic (the translation of x into control commands for the robot by the robot program), the kinematics and dynamics of the robot, and the physical properties of the environment.

In particular, in the context of the claims and preferably in the context of the description, a “trajectory” can be understood as a sequence of vectors sampled with a fixed sampling interval, which can contain information about the state of the robot and optionally also about its environment. Solely as an example as part of an advantageous embodiment, trajectories can contain one or more of the following types of information at each time step:
The position and orientation of the end effector (tool center point (TCP)/tool coordinate system)
The forces and torques applied to the end effector
A status code (p_{erfolg}) between 0 and 1, which indicates whether an error occurred during the execution of the movement, e.g. whether the force specification was violated during a force-controlled movement.

In an extended—purely exemplary—configuration, it would be conceivable and advantageous to extend trajectories to include one or more of the following types of information:
The current joint-angle configuration of the robot. This would significantly facilitate the learning of system models for components the execution semantics of which is defined in the joint angle space (e.g. “point-to-point movement”: linear movement in the joint-angle space).
The positions and orientations of objects in the environment that are manipulated by the robot. This would make it possible to formulate target functions for parameter optimization via relations between objects, for example “Object A should be located between object B and object C after the movement” or “Object A should keep contact with object B during program execution”.

Advantageously, parameter domains can be defined for the optimizable program parameters of the critical program components, wherein the optimizable program parameters are optimized over the parameter domains. A parameter domain represents a permissible value range for the optimizable program parameter. Advantageously, a permissible value range or parameter domain is provided for each program parameter that can be optimized.

In a further advantageous way, the parameter domains for the optimizable program parameters of the critical program components can be specified and/or are predefinable or adjustable. Thus, a domain can also be preset. This means that the parameter domain for a program parameter could already be specified by the underlying system. Furthermore, it is conceivable that a robot programmer/user selects a parameter domain for the program parameters of the critical program components to be optimized, over which the optimization will be performed. This parameter domain is application-specific and advantageously can be chosen narrowly enough to meet safety requirements on the manufacturing process as well as minimum quality and cycle-time requirements.

With a view to obtaining suitable training data, the optimizable program parameters can be sampled from their respective parameter domain during the exploration phase to sample the parameter space. This means that the program parameters that can be optimized are randomly selected as a sample from the parameter domain. It is conceivable that the optimizable program parameters are sampled in an equally distributed manner, i.e. an equally distributed sampling is carried out. This provides the advantage that any sampling errors are spread widely across the sampling space. Equally distributed sampling provides sufficient randomness to avoid systematic undersampling, while ensuring uniform coverage of the parameter space. Furthermore, it is conceivable that the optimizable program parameters are sampled adaptively. Thus, an adaptive sampling can be performed that conveniently samples there or in the regions where more information is needed.

Advantageously, the robot program can be stored in a serialized form, preferably in a database, in a format that allows a reconstruction and parameterization of the robot program or its program components. Also advantageously, the format may comprise a sequential execution sequence of the program components, types of program components, IDs of program components, constant program parameters, and/or optimizable program parameters. The format and the stored data can therefore enable a particularly efficient handling and implementation. Further advantages of these features include the possibility to create the overall system models, consisting of sequences of the component representatives for the components contained in the program structure, fully automatically based on the stored program structure, component types and component parameters. Another advantage is the facility to reuse data from earlier explorations (possibly for other robot programs) in parts for training new component representatives (e.g. for execution in modified environments, etc.) for components of the same component type at any later time, as the specified format allows the subsequent readout of component types and parameters.

In an advantageous way, for one or for each execution of the robot program carried out in the exploration phase, a resulting sampled trajectory can be stored in such a way that an associated program component and a parameterization of the associated program component can be uniquely assigned to each data point of the trajectory at the time of the respective execution. This enables particularly efficient handling and implementation of the data stored with the trajectory. An advantage of this format is the possibility to use the stored data retrospectively at any later point in time for training new component representatives of the same type, since the sub-trajectories for program components of specific types can be directly assigned and extracted from the overall trajectory.

With regard to the collection of training data in the exploration phase, the robot program can be executed automatically, wherein at least 100 executions, preferably at least 1000 executions, of the robot program are carried out to obtain the training data. The automated execution of the robot program has the advantage that no human resources are tied up during the exploration phase and it enables the time- and resource-efficient collection of real training data. The number of executions of the robot program during the exploration phase advantageously affects the quality of the program parameters optimized in the inference phase, since a higher number of training data samples means a finer sampling of the parameter space and the system behavior, allowing the neural networks underlying the component representatives to learn to approximate the system behavior more robustly and more precisely given different parameters. Since the component representatives form the basis for the system for optimizing the program parameters, with larger amounts of training data comprehensively optimized parameter sets can be expected that come closer to the globally optimal parameterization.

The training data collected in the exploration phase for each execution of the robot program can advantageously comprise a parameterization, in particular constant and/or optimizable program parameters, of the critical program components and a resulting sampled trajectory of the critical program components. This means that the component representatives can be generated during the learning phase. The optimizable program parameters that were randomly sampled, i.e. randomly generated, in the exploration phase can thus be stored as part of the training data and associated with the execution of the robot program. The common storage of program parameters and trajectories simplifies the implementation considerably, since only one database or one storage format needs to be integrated.

Advantageously, the training data collected in the exploration phase for each executed program component can additionally comprise an ID (that is, an identifier or a code) and/or a status code. The ID can be used to assign a component and a parameter to the component, as well as a trajectory to the component. The status code can be used to store success/failure of the execution and can therefore be an important part of the program component semantics that the component representatives can learn. Thus, for example, the error rate can be minimized as a target function for the optimization. As a result, the range of possible target functions to use is expanded.

With regard to the efficient generation of component representatives, in the learning phase for the critical program components, learnable component representatives can be generated first, wherein the learnable component representatives are trained with the training data of the exploration phase, in order then to represent system models for sub-processes encapsulated in the associated critical program components as trained component representatives. This enables the simple software-based implementation of component representatives as object-oriented classes (for each type of program component there is one (software) class, which includes the implementation of the trajectory generator for this component type, the architecture of the neural network, and the logic necessary for the training). These classes only need to be developed once (e.g. as part of a software product for graphical robot programming) and can then be repeatedly instantiated to specific component representatives, the neural network of which is then trained.

Advantageously, the component representatives can comprise a recurrent neural network. This provides a universal applicability. Since the recurrent neural network uses a deep neural network as a system model, the described procedure does not make any assumptions about the nature (e.g. parametric distribution, normal distribution, linearity) of the input and output data and can therefore be used in all production domains as well as in principle for all component types. Since no further requirements are placed on the target function except for the ability to be differentiated, any target functions are conceivable. The method can therefore be used in any application domain, such as assembly, surface treatment or handling, and enables the optimization of robot programs with regard to any process indicators or quality criteria.

With regard to an efficient generation of component representatives, an analytical trajectory generator can be placed upstream of the recurrent neural network, which is conveniently implemented in a differentiable form. The analytical trajectory generator is designed to generate a prior trajectory. Since long, finely sampled trajectories in particular contain a lot of redundant information and when using neural networks for prediction large sequence lengths can significantly complicate the learning problem, this is counteracted by placing an analytical trajectory generator upstream of the neural network. This generates a prior trajectory. For example, the trajectory generator can consist of a differentiable implementation of an offline robot simulator. Thus, for example, software libraries for motion planning with robots, such as Orocos KDL (https://www.orocos.org/kdl) or Movelt (https://moveit.ros.org/) can be modified by adding a capability to differentiate the output (the prior trajectory) with respect to the input parameters. Specifically, the algorithms implemented there for motion planning can be converted into differentiable calculation graphs. This conversion can be performed in an exemplary implementation according to one exemplary embodiment by reimplementing the planning algorithms using the software library PyTorch (https://pytorch.org/), which guarantees the differentiability. The prior trajectory can correspond to a generic execution of the program component without considering the environment, i.e. in an artificial space with zero forces and under idealized robot kinematics and dynamics, starting from a given initial state. This strong prior can be combined with the component parameters to form an augmented input sequence for the neural network. The network can then be trained to predict the residual between the prior and posterior (i.e. actually measured) trajectory, as well as the probability of success of the component execution. The addition of residual and priors can result in the expected posterior trajectory output for this program component and the given component parameters. A simplification of the learning problem in the training of neural networks by the introduction of strong priors is established practice. The use of strong priors can significantly reduce the need for training data by an order of magnitude. This effect is particularly noticeable in long trajectories or with strongly deterministic trajectories. The use of a differentiably implemented analytical generator as a strong prior is therefore particularly advantageous.

Advantageously, the target function can be defined in such a way that the target function maps a trajectory to a rational number and that the target function is differentiable with respect to the trajectory. The use of a consistent function signature for the target function allows the simple exchange of target functions without having to adapt the optimization algorithm. The proposed signature is sufficiently simple (target function as an evaluation of a trajectory with a numerical value), to ensure simple implementation, but at the same time allows the implementation of almost any target function. The differentiability of the target function with respect to the trajectory allows the use of gradient-based optimization methods for the parameter inference, which by examining the gradient information, converge in a goal-oriented manner in the direction of at least local optima and therefore converge much faster than non-gradient-based optimizers for many classes of target functions.

Advantageously, the target function can comprise a predefined function, a parametric function, and/or a neural network. Three types of target functions are thus possible. These three types can also be advantageously combined with one another in arbitrary ways. Predefined functions can relate to classical process parameters such as cycle time or path length, which output a variable to be minimized. Parametric functions can include predefined functions that have additional, possibly user-definable, parameters. Examples are distance functions to specified values such as contact forces, tightening torques, or Euclidean target poses. Neural networks can also be used as differentiable function approximators for complex target functions.

Examples of simple target functions that map process parameters are cycle time, path length, and/or error rate. Other more complex types of target functions may include, for example, compliance with force limits, force minimization with simultaneous cycle time minimization, increase of precision (e.g. in stochastic position deviations of workpieces), minimization of torques, specification of particular force or torque curves, etc.

Advantageously, the target function may include a force measurement-based function. In this case, at least parts of the predicted trajectory are evaluated on the basis of the predicted forces and torques. This is particularly advantageous because the optimization of program parameters with respect to optimality criteria defined over forces is very difficult for human programmers, since the relationships between program parameters and the resulting forces during program execution are difficult for human beings to calculate or understand. Programs for manufacturing processes with critical contact or joining forces are often especially difficult to optimize for human programmers, since the forces applied cannot be systematically calculated by human beings and therefore any set of parameters found by a human programmer by testing different parameterizations will usually be suboptimal. The automatic optimization of program parameters can provide particular added value here.

Advantageously, a critical sub-sequence of the robot program can be selected using the interface for selecting one or more critical program components, wherein the critical sub-sequence comprises multiple critical program components. The component representatives of the multiple critical program components can be combined to form a differentiable overall system model. The overall system model maps the program parameters of the critical sub-sequence onto a combined trajectory, so that for a contiguous sub-sequence of critical program components the optimizable program parameters are optimized with respect to the target function. This enables a holistic parameter optimization. The program parameters of associated program component sequences can be optimized together. This offers added value compared to local optimization at the component level, since interactions with the environment are considered across component boundaries during the optimization. In particular, conflicting parameter configurations between program parts can be automatically balanced against each other. This is the case, for example, when increased speed of a movement reduces the probability of success of a subsequent movement, for example by creating vibrations or bending of pins during contact runs. This holistic approach to optimizing program parameters is of considerable advantage.

As part of an advantageous embodiment of a method according to the invention, input data, procedure, and output data can be specified as follows:
1) Input data:
   Program structure: Type (e.g. spiral search (relative), contact run (relative), gripping, etc.) and sequential execution sequence of the critical program components
   Subset of the program parameters of the critical program components to be optimized
   Domain for each program parameter to be optimized
   Differentiable target function
2) Procedure and data processing:
   Exploration phase: Automatic sampling of the parameter space for each critical component and recording of the resulting robot trajectories
   Learning phase: Generating a learnable representative for each critical component and training of the learnable representatives as system models for the sub-process encapsulated in the associated component
   Inference phase: Combination of the trained representatives into overall system models for each contiguous sequence of critical components and inference of optimal parameters for the specified target function
3) Output data:
   An optimal parameter vector for each critical program component

The result is a robot program with optimal or optimized parameters with respect to a specified target function.

Advantageous embodiments of the invention can provide a method and a corresponding system for the fully automatic inference of optimized program parameters for industrial robots, which allows robot programmers or plant workers during the programming, commissioning and maintenance phases of robot cells to optimize the parameters of complex robot programs in the presence of variable processes and workpieces with regard to cycle time and quality specifications automatically and in a data-driven manner. For this purpose, a method and/or system according to an exemplary embodiment of the invention comprises components or modules or units that are used for automated exploration of the parameter space, modeling, specification of target functions, and the inference of optimal/optimized parameters. A robot program with optimized parameters can be achieved and thus a robot cell with higher throughput, higher manufacturing quality or lower reject levels.

Advantageous embodiments of a method according to the invention or a system according to the invention can have one or more of the following advantages:
Fully automatic parameter optimization: This has the potential to replace the costly and labor-intensive periods of manual fine-tuning of program parameters by automated parameter optimization, both during the commissioning of new robot cells and during the maintenance of existing robot cells. This saves personnel costs, and depending on the plant, time and the plant does not stand idle during any of the three phases of the method according to an exemplary embodiment of the invention (exploration phase, learning phase, inference phase). This is of considerable advantage in the context of parameter optimization for robot programs.
Modeling based on real data: In contrast to simulation-based or purely analytical approaches, an exemplary embodiment of the invention allows a form of process optimization based on real measured data. Exemplary embodiments can in particular enable process optimization with regard to target forces or torques as well as the dynamic properties of the movements, since the trained system models can predict the force profiles of the interaction of the specific robot in the specific environment with the specific existing workpieces. Well-known methods for process optimization from the prior art do not take into account the forces and torques that actually occur, or only to a limited extent, and require well-founded expert knowledge or manual trial and error.
Holistic parameter optimization: The program parameters of associated program component sequences can be optimized together. This offers added value compared to local optimization at the component level, since interactions with the environment are considered across component boundaries during the optimization. In particular, conflicting parameter configurations between program parts of the robot program can be automatically balanced against each other. This is the case, for example, when increased speed of a movement reduces the probability of success of a subsequent movement, for example by creating vibrations or bending of pins during contact runs. This holistic approach to optimizing program parameters is of considerable advantage in industrial robotics.
Efficient modeling and data acquisition: In contrast to known methods according to the prior art for solving optimization problems in robotics, which are based on real training data, for an advantageous embodiment of the invention neither supervised training data nor reinforcement learning are necessary. This enables economic use of the method in industry, as the high level of effort involved in supervised learning and the non-determinism of reinforcement learning that is difficult to implement in industry are avoided. The exploration phase may be integrated into planned commissioning or maintenance phases of the robot cell, allows the cell to be used productively without interruption and does not tie up additional resources, as there is no need for monitoring or manual labeling by the plant worker.
Universal applicability: Since one exemplary embodiment of the invention can use a deep neural network as a system model, the method according to the exemplary embodiment does not make any assumptions about the nature (e.g. parametric distribution, normal distribution, linearity) of the input and output data when building the model and can therefore be used in all manufacturing domains as well as in principle for all component types. Since no further requirements are placed on the target function except for the ability to be differentiated, any target functions are conceivable. The method according to the exemplary embodiment can therefore be used in any application domain, such as assembly, surface treatment or handling, and enables the optimization of robot programs with respect to any process indicators or quality criteria.

There are now various options for designing and further developing the teaching of the present invention in an advantageous manner. For this purpose, reference is made both to the claims subordinate to claim 1 and to the following explanation of preferred exemplary embodiments of the invention on the basis of the drawing. In connection with the explanation of the preferred exemplary embodiments of the invention based on the drawing, generally preferred embodiments and further developments of the teaching are also explained.

In the drawings

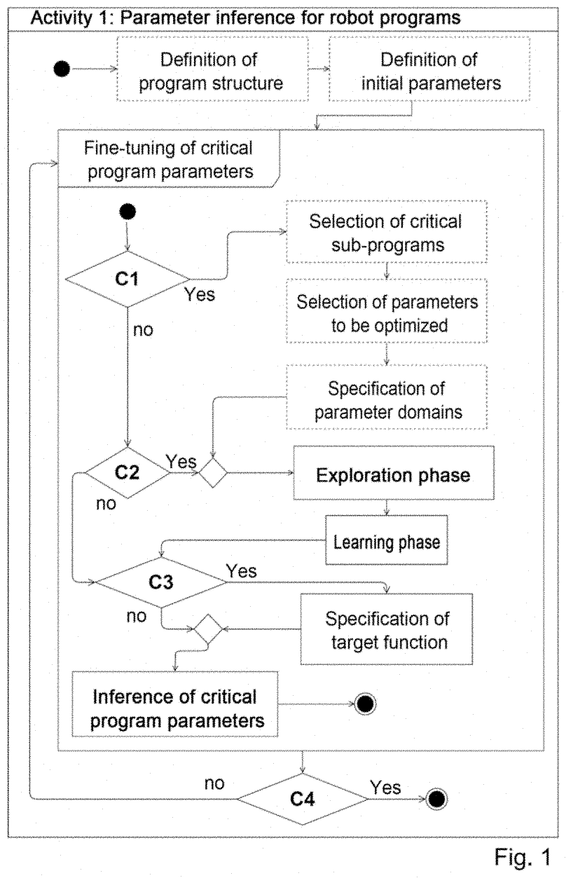

FIG. 1 shows an activity diagram for a method for determining optimized program parameters for a robot program according to an exemplary embodiment of the invention,

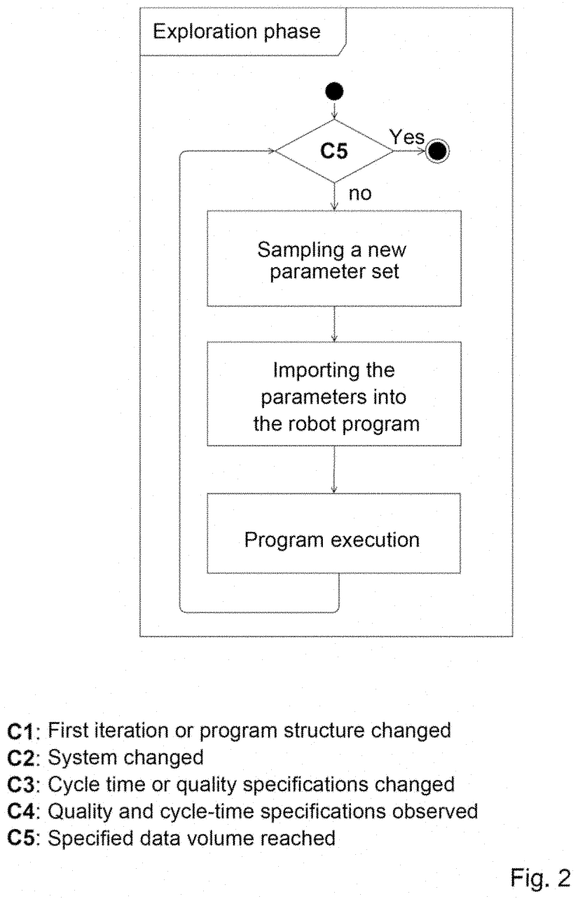

FIG. 2 shows a supplementary activity diagram for the exemplary embodiment according to FIG. 1, wherein the exploration phase indicated in FIG. 1 is illustrated,

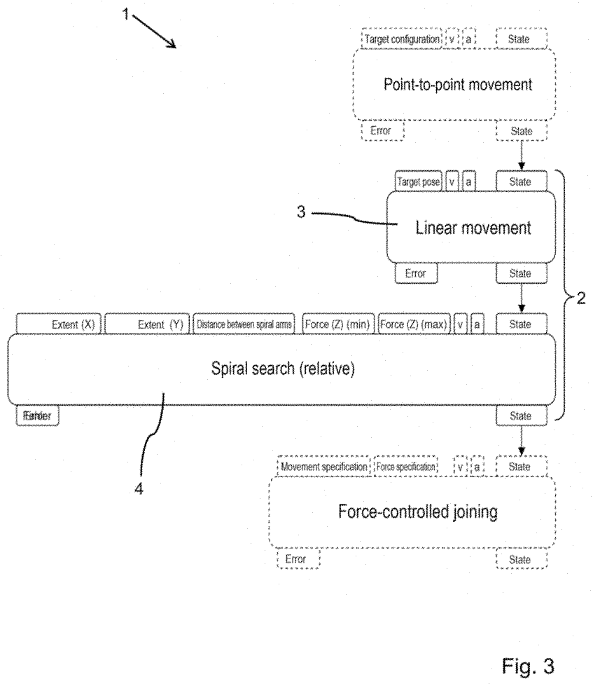

FIG. 3 shows an exemplary robot program for a force-controlled spiral search, wherein the critical sub-program is outlined with a solid line,

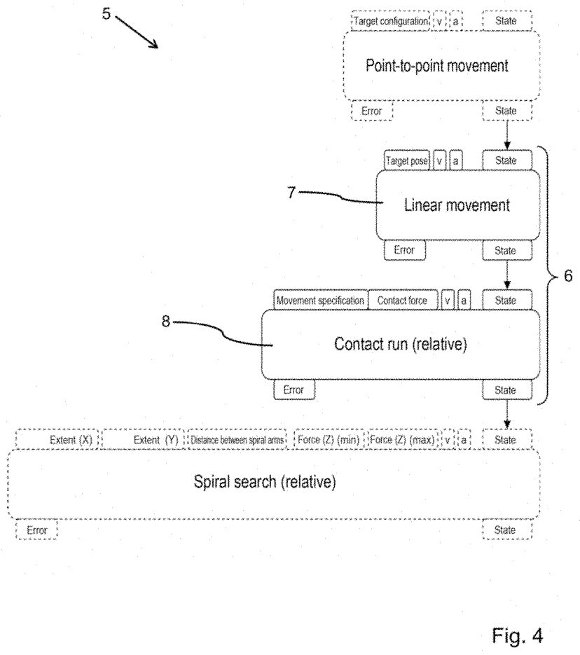

FIG. 4 shows an exemplary robot program for a force-controlled contact run, wherein the critical sub-program is outlined with a solid line,

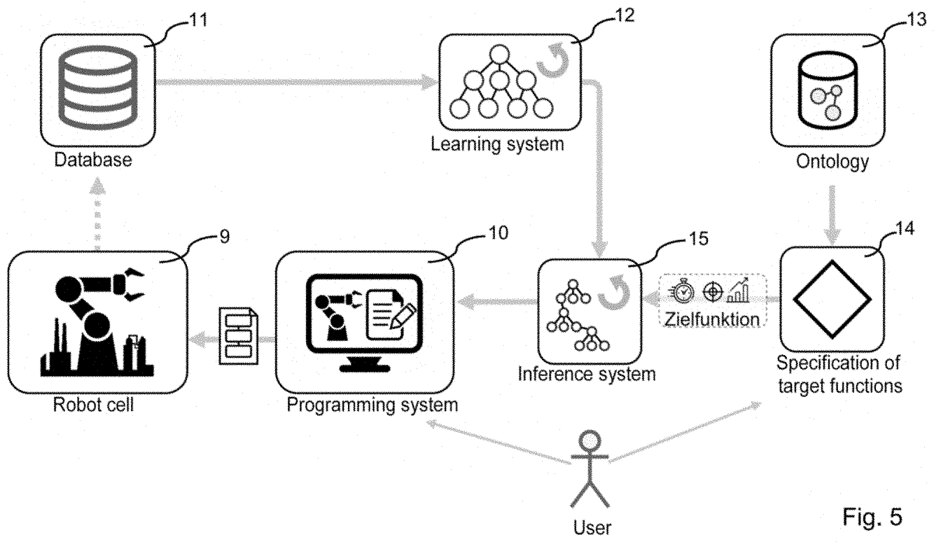

FIG. 5 shows an activity diagram in a schematic view for a system for determining optimized program parameters for a robot program according to an exemplary embodiment of the invention,

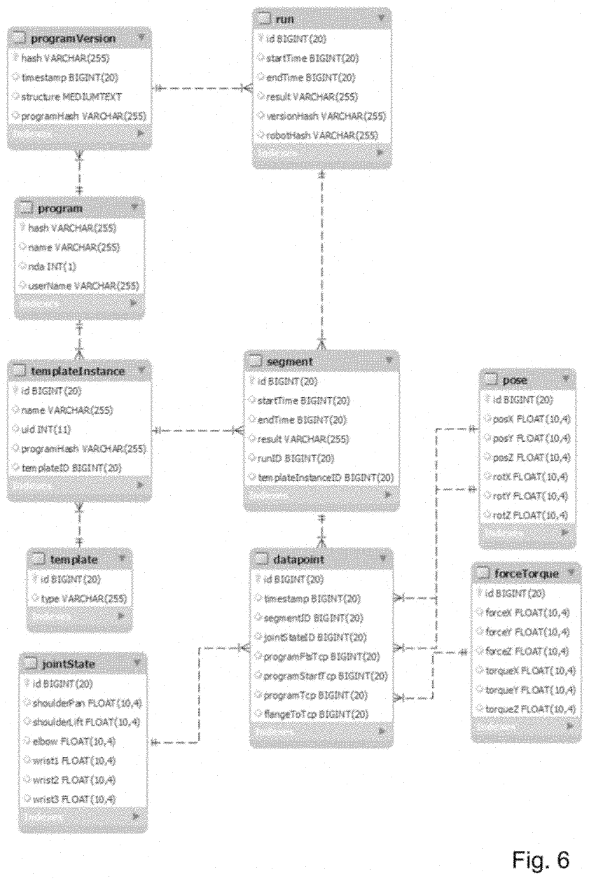

FIG. 6 shows a schematic representation of the database scheme implemented in an exemplary reference implementation for a system or a method according to an exemplary embodiment of the invention,

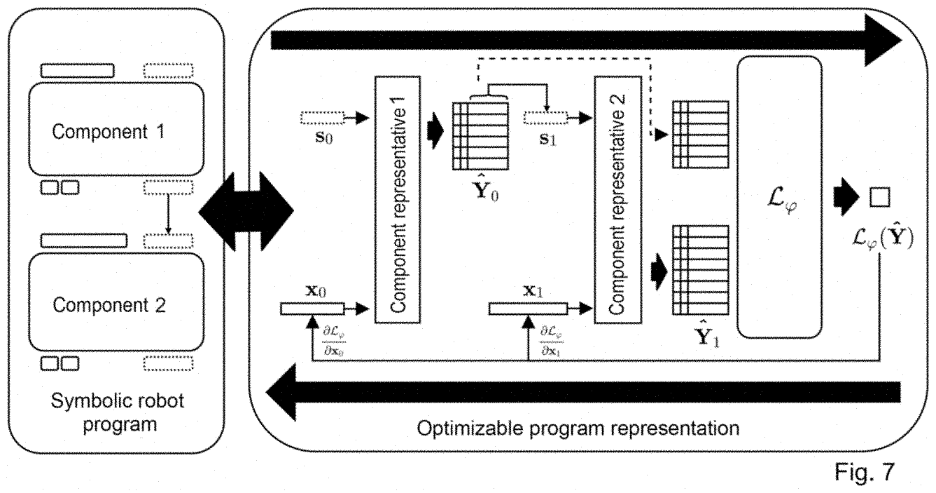

FIG. 7 shows a schematic illustration of a differentiable robot program,

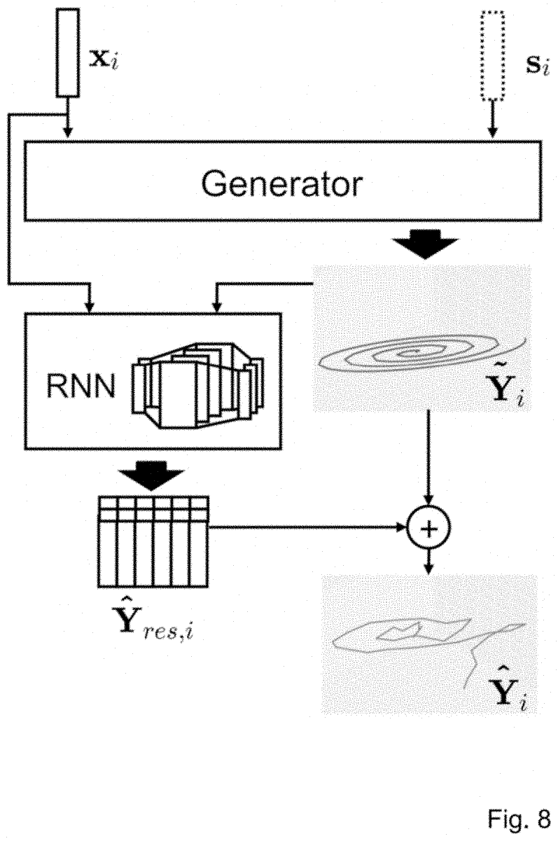

FIG. 8 shows a schematic illustration of a differentiable program component in accordance with one exemplary embodiment of the invention,

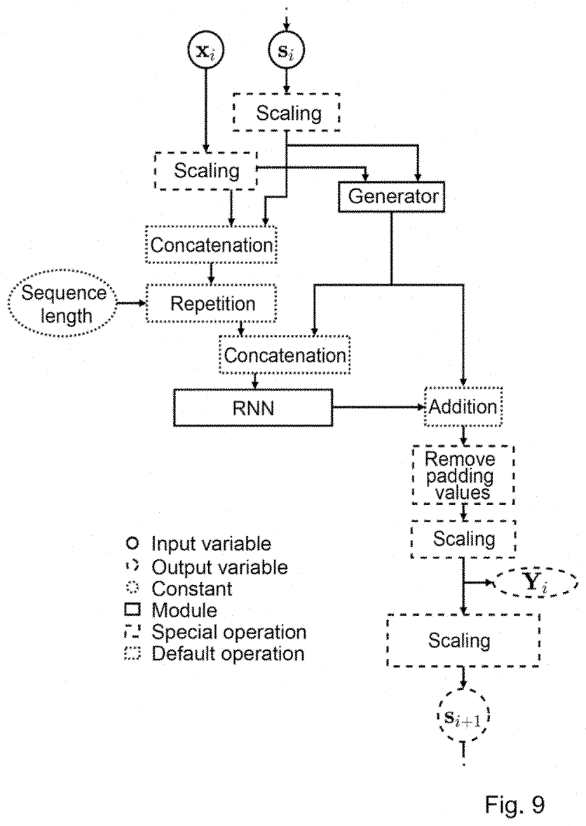

FIG. 9 shows a schematic illustration for illustrating a simplified calculation graph of a differentiable component representative, and

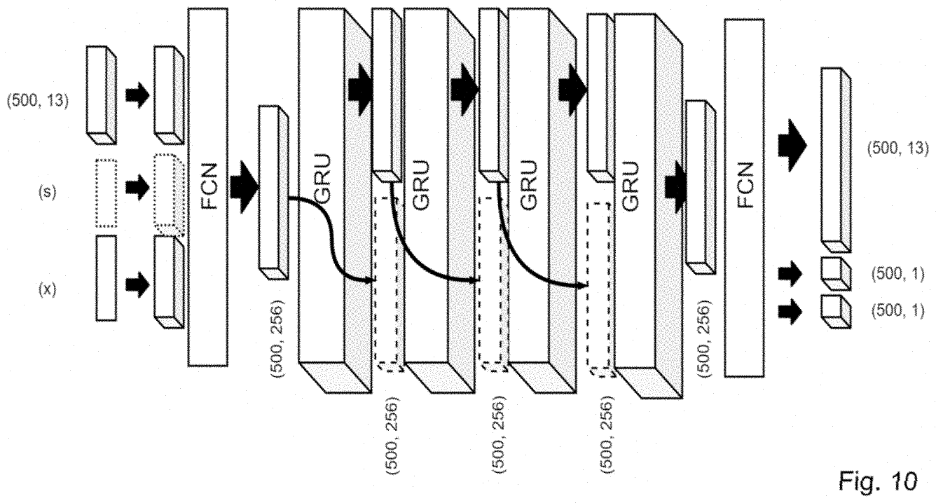

FIG. 10 shows a recurrent network architecture for one exemplary embodiment of the invention.

FIG. 1 and FIG. 2 show an activity diagram for a method for determining optimized program parameters for a robot program according to an exemplary embodiment of the invention,

From a process point of view, the method according to an embodiment of the invention has different versions or possible applications in the programming, commissioning and maintenance phases of production plants or robot cells. FIG. 1 and FIG. 2 show an overview of the method steps of the exemplary embodiment, including optional method steps which can be skipped depending on their type. In general, in each of the three abovementioned phases in the life cycle of a plant or a robot there is a possible variant of the exemplary embodiment. The following describes the method according to the exemplary embodiment for the programming, commissioning and maintenance phases.

### A. Programming Phase

I. Defining the program structure: The robot programmer creates a robot program from parameterizable program components (motion templates), which map atomic movements of the robot. The robot program consists of a sequence of arbitrary force- or position-controlled program components. The sequence of program components maps the steps necessary to solve the application task.
Example of force-controlled spiral search: FIG. 3 shows a schematic illustration of an exemplary semi-symbolic robot program 1 for the force-controlled spiral search. The critical sub-program 2 or the critical program components 3 and 4 of the robot program 1 are solidly outlined in FIG. 3.
Example of contact run: FIG. 4 shows a schematic illustration of an exemplary semi-symbolic robot program 5 for a force-controlled contact run. The critical sub-program 6 or the critical program components 7 and 8 of the robot program 5 are solidly outlined in FIG. 4.

The execution semantics of a component of the type “Linear motion” 3 or 7 (cf. FIGS. 3 and 4) can be described as follows: given a target pose as well as a velocity v and acceleration a, move the robot such that the tool center point (tool coordinate system of the robot) describes a linear path in Cartesian space from the current tool pose to the target pose with the specified velocity and acceleration.

The execution semantics of “Contact run (relative)” 8 (cf. FIG. 4) can be described as follows: given a motion specification relative to the current position of the tool coordinate system of the robot (for example, “1 centimeter translation in z direction and 3° rotation about the X-axis”), a force specification that specifies the contact force along the Z-axis of the tool coordinate system, as well as a velocity v and acceleration a, move the robot along a linear path in Cartesian space according to the motion specification and with the specified acceleration and speed until the specified force is reached. The execution of the motion is considered successful when the force specification has been reached (contact established), otherwise as failed.

II. Definition of the initial program parameters: A robot programmer can manually define the initial parameters of the program components using common methods (teach-in, CAD to Path, . . . ) to solve the application task approximatively (possibly violating the specified cycle times and quality requirements).

III. Fine tuning of the parameters of relevant sub-programs: The robot programmer uses a method according to an exemplary embodiment of the invention for the automatic optimization of program parameters to meet cycle-time specifications and quality requirements.

III.a. Selection of critical sub-programs: The robot programmer selects critical sub-sequences of the program (i.e. critical sub-programs) or individual critical program components, the program parameters of which are to be optimized.
Example of force-controlled spiral search: Here, the critical sub-program 2 consists of the sequence [“Linear motion”, “Spiral search (Relative)”], since the parameters of the linear motion (in particular its target position) fundamentally affect the position and orientation of the spiral search (cf. FIG. 3).
Example of contact run: Here, the critical sub-program 6 consists of the sequence [“Linear motion”, “Contact run (Relative)”], since the Z-coordinate of the target pose of the linear motion in particular fundamentally affects the expected length of the contact run (cf. FIG. 4).

III.b. Selection of the parameters to be optimized: Depending on the environment and application task, certain program parameters of the critical sub-programs or the critical program components must be labeled as constants in order to ensure safety or quality requirements. This concerns, for example, target poses of movements in areas of the robot cell with restricted accessibility or lower or upper force limits of force-controlled movements. The designation of constant parameters is application-specific and requires domain knowledge, but in many cases can be determined already at the cell design stage using the CAD models of the cell, process simulation software, if used, and offline robot simulation software.
Example of force-controlled spiral search: In spiral search movements, primarily speed and acceleration, but also the extent of the spiral along its principal axes, the orientation of the spiral and the distance between the turns are critical to the success of the search action and must therefore be optimized. In addition, the Z-component of the orientation of the target pose of the preceding linear motion (in Tait-Bryan angles) is relevant, as this specifies the orientation of the (planar) spiral. The parameters [Extent (X), Extent (Y), Distance between spiral arms, v, a] of “Spiral search (relative)” as well as the Z-rotation component of the target position input of the linear motion can therefore be optimized, all other parameters are labeled as constant (cf. FIG. 3).
Example of contact run: In order not to exceed force limits, speed and acceleration are particularly critical. The Z-component of the upstream linear motion together with the position of the workpiece determines the length of the contact run. Optimizable parameters here are [v, a] of “Contact run (relative)” and the z-coordinate of the target pose input of “Linear motion” (cf. FIG. 4).

Program parameters of a program component can be either input (target poses, target forces, etc.) or intrinsic parameters (velocity, acceleration). Both parameter types can be optimized.

III.c. Definition of the domain for optimizable parameters: For each program parameter of the critical sub-programs or the critical program components that is to be optimized or optimizable (i.e. not constant), the robot programmer can select a permissible value range over which the parameter is to be optimized. This is application-specific and usually sufficiently narrow that all safety requirements on the manufacturing process as well as minimum quality and cycle-time requirements can be satisfied.
Example of force-controlled spiral search: The speed and acceleration limits of successful spiral searches are strongly dependent on the robot and the environment, but are usually in the range [0.001 m/s, 0.005 m/s] and [0.001 m/s², 0.05 m/s²] respectively. The expected scatter of the hole positions is typically in the millimeter range, and the limits for the extent and the turn interval of the spiral are determined accordingly. The domain of the Tait-Bryan z-component of the target pose of the linear motion is based on the approximate point symmetry of the spiral [0, 180°] (cf. FIG. 3).
Example of contact run: Here, the correct restriction of the velocity domain is safety-critical, since during fast contact runs, forces of any magnitude can occur before the force controller stops the movement. Restriction of the domain must also be used to prevent a collision with the workpiece during the execution of the linear motion (cf. FIG. 4).

III.d. Exploration phase: An automatic stochastic exploration of the parameter space is carried out. The robot program is now executed automatically under realistic conditions, but not yet in the production environment (for example, 1000<N<10,000). For each execution, the program parameters to be optimized are sampled from their respective domain. For example, this takes place via an equally distributed sampling. During execution, the position and orientation of the tool center point (TCP) of the robot as well as the forces and torques occurring at the TCP are sampled at an arbitrary but fixed sampling interval (8 ms<Δt<100 ms) and stored in a database. In addition to the data of each executed program component, an ID with which the program component can be identified in the robot program as well as a status code are transferred from the robot to the database. The status code identifies whether the executed action was successfully completed, according to the semantics of the program component. Force-controlled runs to contact end successfully, for example, if contact has been established and the contact force is within a set tolerance range. In addition, the randomly generated program parameters are stored in the database and associated with the program execution. The sampling interval Δt is application-specific and can be specified by the programmer. Large sampling intervals reduce the amount of data to be processed and stored and simplify the learning problem, reducing the number of necessary program executions (N), but leading to aliasing and undersampling in high-frequency or vibrating processes. The number of program executions N is also application-specific and depends on the complexity and length of the robot movements, the (non-)linearity of the force and torque profiles during interactions of the robot with the environment, and the stochasticity of the process. If workpiece variances are expected, workpieces of different batches should be used during the exploration phase in order to teach in the workpiece variances.

III.e. Learning phase: The system models are automatically trained. For each program component of the critical sub-programs, on the basis of the previously collected parameter sets and trajectories a system model is learned which maps the component parameters to the expected positions and orientations of the TCP, the expected forces and torques as well as the expected status code. No user interaction is required for the training. The duration of the training depends on the number and complexity of the program components as well as on the number, length, and sampling characteristics of the trajectories in the training data set.

In this context, a “system model” can be defined as a mathematical function ƒ, which outputs the expected trajectory Ŷ given the input parameters x and the system state p. ƒ therefore implicitly includes the program logic (the translation of x into control commands for the robot by the robot program), the kinematics and dynamics of the robot, and the physical properties of the environment.

III.f. Specification of the target function: An arbitrary target function is defined, with respect to which the program parameters are to be optimized. Each target function is valid if it maps a trajectory to a rational number and can be differentiated with respect to the trajectory. Concave target functions simplify the optimization problem because they only have one (global) maximum and the result of the optimization is independent of the initial parameterization. For non-concave target functions with local maxima, the optimization is sensitive to the initial parameterization. Arbitrary target functions can be combined by weighted addition, wherein local maxima can be created by the addition. By using iterative Monte-Carlo methods, the convergence of the optimization to globally optimal parameter sets, given the correctness of the learned system model, can be asymptotically guaranteed. The specification of the target function is application-specific and may need to be carried out by an expert in the respective production domain. A gradient-based optimization method is used for the optimization and the target function is expressed as a loss function for the equivalent minimization problem. Examples of simple loss functions are the cycle time, the path length in the Cartesian or configuration space, or the error probability. Complex loss functions are the distance to one or more reference trajectories, for example from human-performed demonstrations, or the deviation of specified contact forces at the end of a trajectory or during the execution of a program component. An initial target function can be automatically generated by inference over a knowledge base from the semantics of the components of the critical program parts and adjusted by the programmer using a graphical user interface.
Example of force-controlled spiral search: By specifying a combined loss function from error probability and cycle time or path length, force-controlled spiral search movements can be optimized for the optimum balance between cycle-time and reject minimization. With regard to the learned system model, the optimization results in parameters that optimally balance the radii along the principal axes, distance between the turns, orientation, velocity, and acceleration.
Example of contact run: Force-controlled contact runs can be optimized in their dynamic properties such that the average target force is achieved as precisely as possible, by specifying a loss function proportional to the distance of the predicted force along the Z axis from a specified target force.

III.g. Inference phase: The system models are optimized automatically. For each critical sub-program, the learned system models of the associated program components are automatically combined to form an overall model, which maps the parameters of the sub-program to the combined sub-trajectory. A gradient-based optimization algorithm iteratively optimizes the program parameters with respect to the specified target function. The optimized program parameters are automatically transferred to the robot program.
Example of force-controlled spiral search: In spiral search movements, global parameter optima typically result in maximum coverage of the probability mass of the expected hole distributions while simultaneously maximizing velocity and acceleration to the point where further velocity increases come at the cost of excessive error rates. The orientation of the principal axes of the spiral are matched to the principal axes of the hole distribution.
Example of contact run: After optimization the velocity and acceleration parameters of contact runs guarantee the maximum possible probability of reaching and not exceeding the specified target contact force. With simultaneous cycle time minimization, the length of the contact run is minimized by lowering the target position of the preceding linear motion.

IV. Manual acceptance by the programmer/user: The robot programmer runs the optimized robot program repeatedly and ensures compliance with all safety, cycle-time and quality requirements. Quantitative, statistical methods may be used for the measurement and process parameters.

### B. Commissioning Phase

I. Adjustment of program parameters during ramp-up: Once the robot cell has been integrated into the rest of the production line, production usually starts with lower quality, reduced quantities, or higher reject rates. This is often due to minimal deviations in the environment, workpieces or structure compared with the programming phase. The usual practice is the manual, iterative adjustment of the program parameters in order to bring the process back within the specified cycle-time and quality limits. Existing tools for automatic process optimization or for tuning controller parameters only partially automate the optimization process and only for certain parameters or movements. Using a simplified version of the procedure described in A.III, the operator can adjust the parameters of the robot program fully automatically to suit the changed conditions. Steps A.III.a to A.III.c can be skipped, because the hyperparameters of the method set there are robust against stochastic changes in the system or environment. The number of training data samples required (cf. A.III.d) is a factor of 10-20 lower than in the programming phase, since the existing system models can be reconditioned to the changed environment using transfer learning methods. Step A.III.f can also be skipped in many cases if the cycle-time and quality specifications have not changed compared to the programming phase. Here, however, it is also possible to adapt the target function to the changed conditions in the plant.
Example of force-controlled spiral search: During commissioning, the integrator notices that components from a different manufacturer are used in production than those for which the robot cell was finely adjusted during the programming phase. For example, the mean orientation of the pins of electronic components has a stochastic offset of up to 2° compared to the programming phase, which causes a large number of search movements to fail and the cycle-time specifications can no longer be met. By retraining the system model and parameter inference, the distribution of the offset can be implicitly estimated and compensated by the new program parameters.
Example of contact run: During commissioning, the plant worker notices that due to the transport of the cell, the positioning of the boards to be populated deviates on average by 1 mm in the Z-direction from the expected height, which means that contact runs for placing components take 0.5 seconds longer on average. The original cycle time can be restored by retraining the system model and parameter inference.

### C. Maintenance Phase/Series Production

I. Compensation of process and workpiece variances: During production runs, changes in the environment, the production plant or the workpieces may occur. If a manufacturer or batch is changed, components may have different surface or bending properties. In addition, the system behavior can change over the course of the operating time of the plant due to maintenance work on the plant, replacement of motors and sensors, or wear effects. Using a simplified version of the procedure described in A.III, the operator can adjust the parameters of the robot program fully automatically to suit the changed conditions. Steps A.III.a to A.III.c can be skipped, because the hyperparameters of the method set there are robust against stochastic changes in the system or environment. The number of training data samples required (cf. A.III.d) is a factor of 10-20 lower than in the programming phase, since the existing system models can be reconditioned to the changed environment using transfer learning methods. Step A.III.f can also be skipped if the cycle-time and quality specifications remain the same.
Example of force-controlled spiral search: Due to wear effects of the positioning system of the electronic circuit boards to be populated, the variance of the hole positions has increased significantly after long operation of the production system, so that the circuit boards can no longer be reliably populated. By retraining the system model again, the new hole distribution can be implicitly estimated and the spiral search movements can be re-parameterized by parameter inference in order to comply with the quality specifications by expanding the search region and refining the search grid.

II. Adaptation to new target specifications: If, for example due to reconfigurations at other points on the production line, cycle-time specifications or quality requirements change, the operator can adapt the parameters of the robot program to the new specifications by executing steps A.III.f and A.III.g by specifying a corresponding target function. The existing system models remain valid and can be reused without retraining.
Example of contact run: Due to a supplier change, the pins of the installed electronic components are less resilient than before and become warped at the currently designated contact force. By reducing the force specification of the corresponding target function and repeated parameter inference without retraining, a new parameterization can be found which ensures the new, lower contact force.

FIG. 5 shows a schematic view of an exemplary system architecture with individual system components for a system for determining optimized program parameters for a robot program according to an exemplary embodiment of the invention,

### System Components:

a. Robot cell 9 with six-axis industrial manipulator: It is assumed that it is possible to measure forces and torques at the TCP. An external force-torque sensor may be required for this.

b. Component-based graphical programming system 10 for programming and executing robot programs: For the creation of the initial robot program, its parameterization and execution on the robot controller, a software system with a graphical user interface is required which can process semi-symbolic robot programs, compile them into executable robot code and execute them on the robot controller.

c. Database 11 for robot programs and trajectories: In database 11 robot programs are stored in serialized form in a format that allows the reconstruction of the program structure and parameterization (execution sequence, type and unique IDs of the program components, constant and optimizable parameters of the program components). For each execution of the robot program, the database contains a sampled trajectory consisting of the position and orientation of the TCP, forces and torques on the TCP, and the status code of the program component belonging to the data point. The memory format is such that the associated program component and the parameterization of the program component can be uniquely assigned to each data point of a trajectory at the time of execution. FIG. 6 shows a schematic representation of the database schema implemented in an exemplary reference implementation.

d. Learning system 12 for differentiable component representatives: The learning system 12 transforms a serialized representation of the program structure of the critical sub-programs into a set of differentiable (parameter-optimized) motion primitives. Each differentiable motion primitive is a functionally equivalent analog (“representative”, “system model”) to a component instance from the sub-program, which maps the parameters of the component instance onto a trajectory expected during execution.

A component representative is defined as a system model at the component level or a model of the execution of the corresponding program component. A component representative for program component B is therefore a mathematical function ƒ_{B} which, given the input parameters x_{B} of the program component and the system state p, outputs the expected trajectory Ŷ_{B} that will result when the program component is executed on the robot. Component representatives are therefore mathematical models of the execution of program components. These models can be learned on the basis of training data and can be differentiated, i.e. they allow the calculation of the derivative of Ŷ_{B} with respect to x_{B}. This allows the optimization of x_{B} with gradient-based optimization methods. Since all component representatives are differentiable models of the execution of program components, a program according to FIG. 7 composed of component representatives can also be differentiated and enables the joint optimization of the parameters of all the component representatives contained in the program for a target function over the entire trajectory. This differentiable and thus optimizable representation of robot programs is the basis of an optimization procedure for program parameters according to an exemplary embodiment of the invention.

e. Knowledge base or ontology 13 of component-specific sub-targets: In many cases, the target function for the parameter optimization contains sub-targets that result directly from the execution semantics of the component types. For example, a force-controlled contact run has an implicit contact target in a specified force range. These implicit sub-targets are stored in a knowledge base in the form of an ontology. At the time of the specification of the target function, reasoning over the ontology is used to create an initial target function from the given program structure, which maps these implicit sub-targets. This can be adapted by the user and supplemented by additional application-specific sub-targets. The use of ontologies or knowledge bases for automatic bootstrapping of target functions represents a major advantage.

An ontology is a structured representation of information with logical relations (a knowledge database), which makes it possible to draw logical conclusions (reasoning) from the information contained in the ontology using suitable processing algorithms.

Most ontologies follow the OWL standard (https://www.w3.org/OWL/). Examples of ontologies are BFO (https://basic-formal-ontology.org/) or LapOntoSPM (https://pubmed.ncbi.nlm.nih.gov/26062794/). The most common software framework for reasoning is HermiT (http://www.hermit-reasoner.com/). OWL and HermiT can be used in an exemplary implementation according to an exemplary embodiment.

In an exemplary reference implementation according to an exemplary embodiment of the invention, the developed ontology forms a “database for predefined target functions”, on which by reasoning from a given semi-symbolic robot program it is possible to automatically derive target functions which due to the fixed semantics of the program blocks must always be valid, for example, that a “Contact run (relative)” component should produce a contact force along the Z-axis of the tool coordinate system or that in a “linear motion” component the target point should be reached as precisely as possible. This reduces the task of specifying the target function for the user to the aspects of the target function that do not already follow from the semantics of the program components, but, for example, from the application (contact forces, speeds, . . . ) or for business-related reasons (minimization of the cycle time, . . . ).

f. System 14 for specifying differentiable target functions: Differentiable target functions are initially calculated in software by means of reasoning over the knowledge base of the component-specific sub-targets and can then be edited by the user using an interface if necessary. The resulting internal representation of the combined target function is then translated into a differentiable calculation graph of the loss function for the equivalent minimization problem.

Three types of target functions are possible and can be combined with one another as required:
Predefined functions: Classical process parameters such as cycle time or path length, which output a variable to be minimized. If the above user interface is used, these must only be selected by the user.
Parametric functions: Predefined functions that have additional user-definable parameters. Examples are distance functions to specification values such as contact forces, tightening torques, or Euclidean target poses. The specified values can be set by the user via an interface.
Neural networks: Since any differentiable functions can be used as target functions, neural networks can also be used as differentiable function approximators for complex target functions.

g. Inference system 15 for optimal robot parameters: The inference system 15 forms an end-to-end optimizable calculation graph for each critical sub-program by considering the specified target function and the trained component representatives. On this graph, the inference algorithm calculates the optimal program parameters for the specified target function. This system is novel in its design and application in industrial robotics.

### External Interfaces:

Graphical user interface for creating, editing and executing robot programs: A graphical user interface is provided for the initial creation and manual editing of program structure and program parameterization. In an exemplary reference implementation of a method according to an exemplary embodiment, the ArtiMinds Robot Programming Suite (RPS) is used as an interface to create and parameterize robot programs in the semi-symbolic ArtiMinds Robot Task Model (ARTM) representation. The user interface also provides infrastructure for running loaded robot programs on the robot controller.
Machine interface for reading, writing and saving robot program structure and parameterization as well as version control: During the learning phase, the parameter space is randomly sampled and the parameterized robot programs are stored in a database in a version-controlled form (cf. System component a.). In order to automate this process, a machine interface is provided to import parameter sets generated by the learning framework into the robot program, and to store the parameterized robot program after execution permanently in a database with version control in order to associate the resulting trajectory with the program structure and parameterization at the time of training. In the exemplary reference implementation, the control plugin of the ArtiMinds RPS fulfills this function.
Machine interface for recording robot trajectories: The executed robot trajectories are sampled. The position, orientation, force and torque data that can be read off the robot controller are transformed geometrically into poses, forces and torques at the TCP in world coordinates. After each component has been executed, a Boolean value is calculated on the robot controller, which indicates whether the component has been executed successfully. This data is transferred to a database via a machine interface. Both database and interfaces are provided in the exemplary reference implementation by the ArtiMinds RPS and LAR (Learning and Analytics for Robots).
User interface for creating and editing differentiable target functions: The exemplary reference implementation comprises a console-based dialog system, via which the user can interactively adapt the sub-targets calculated in advance from the knowledge base and supplement them with further sub-targets.

In the context of an exemplary embodiment of the invention, the following phases—namely exploration phase, learning phase and inference phase—can be executed and implemented, components of this exemplary embodiment being illustrated by FIGS. 8, 9 and 10:

### Exploration Phase:

Automatic sampling of the parameter space: The automatic random sampling of parameter configurations (or the optimizable program parameters) from their respective domains was implemented in an exemplary reference implementation using the external programming interface of the ArtiMinds Robot Programming Suite.

### Learning Phase:

Generating a learnable representative for each critical component: Core of a system according to the exemplary embodiment is a representation of program components, which allows the gradient-based optimization of the parameters with respect to a target function. Basically, the inference problem of optimal parameters is divided into a learning phase and an inference phase, wherein in the learning phase a model of the system (robot and environment during the execution of a module) is learned and in the inference phase a gradient-based optimization algorithm optimizes the input parameters of the component representative using the learned system model.

Component representatives map the component parameters to an expected trajectory and guarantee the differentiability of the output trajectory with respect to the component parameters. This mapping is realized by means of a recurrent neural network. Since long, finely sampled trajectories in particular contain a lot of redundant information and when using neural networks for prediction large sequence lengths significantly complicate the learning problem, an analytical trajectory generator is placed upstream of the neural network, which generates a prior trajectory (cf. FIG. 8). In a reference implementation of the method according to the exemplary embodiment, the trajectory generator consists of a differentiable implementation of an offline robot simulator. The prior trajectory can correspond to a generic execution of the program component without consideration of the environment, i.e. in an artificial space with zero forces and under idealized robot kinematics and dynamics, starting from a given initial state. This strong prior is combined with the component parameters to form an augmented input sequence for the neural network. The network is trained to predict the residual between prior and posterior (i.e. actually measured) trajectory as well as the probability of success of the execution of the component (cf. FIG. 8 and the simplified calculation graph in FIG. 9).

The addition of the residual and priors results in the output expected posterior trajectory for this program component and the given component parameters. Simplifying the learning problem in the training of neural networks by introducing strong priors is established practice. Algorithmic priors can be defined both by the specific network structure (cf. R. Jonschkowski, D. Rastogi, and O. Brock, “Differentiable Particle Filters: End-to-End Learning with Algorithmic Priors,” ArXiv180511122 CS Stat, May 2018, Accessed: Apr. 3, 2020. [Online]. Available at: http://arxiv.org/abs/1805.11122) as well as by representing the output values as parameters of predefined parametric probability distributions (cf. the use of Gaussian processes, for example, in M. Y. Seker, M. Imre, J. Piater, and E. Ugur, “Conditional Neural Movement Primitives”, p. 9) or Gaussian mixes in A. Graves, “Generating Sequences with Recurrent Neural Networks,” ArXiv13080850 Cs, June 2014, Accessed: Nov. 22, 2019. [Online]. Available at: http://arxiv.org/abs/1308.0850). In this case, aspects of the velocity profile, the coarse positioning in the working space in absolute coordinates as well as deterministically pre-planned movements are generated by the generator and no longer need to be learned. In the case of force-controlled spiral search movements, the problem is partially linearized, since the deterministic spiral shape does not have to be learned as well, but only the deviations of the real from the planned trajectory. The use of strong priors can significantly reduce the need for training data by an order of magnitude. This effect is particularly noticeable in long trajectories or with strongly deterministic trajectories. When training a component representative for the force-controlled spiral search, the required amount of training data can be reduced by a factor of 20 as part of one exemplary embodiment. The use of a differentiably implemented analytical generator as a strong prior is a considerable advantage.
Representation of the parameter vectors: The parameter vectors xᵢ of each component representative i are component-dependent and are the result of the concatenation of the respective parameters. Pose-valued parameters can be represented as vectors of length 7, with the first 3 entries representing the position in Cartesian space and the last 4 entries representing the orientation as a quaternion. The quaternion representation has the advantage that they can be interpolated without singularities and the individual components assume smooth curves over time, which significantly simplifies the learning problem. Forces and torques can be represented as vectors of length 6, which designate the forces along the 3 Cartesian spatial directions and the torques around the 3 Cartesian spatial axes. The parameter vectors xᵢ contain both optimizable and constant parameters. In principle, the component representatives can xᵢ contain fewer or different parameters than the corresponding program components, as long as a bijection exists between the parameter vectors and the behavior is the same with the same parameterization. This is the case, for example, with “Spiral search (relative)”: for the calculation of the search region, the ARTM module accepts four poses, which lie in a plane and describe the four corners of a parallelogram relative to the starting pose. For the component representative, this representation is converted into two real numbers which describe the extent of the parallelogram in the x- and y-directions. This representation is much more compact, but mathematically equivalent. Long values of xᵢ complicate the learning and inference problem significantly, and therefore the most compact representations of the parameters are advantageous.
Representation of the state vectors: In an exemplary implementation, sᵢ consists of the TCP pose of the last data point of the predicted trajectory, using the convention for poses described above. Depending on the form of the method, sᵢ can exist around forces and torques, the joint-angle position of the robot or the poses of manipulated objects or objects detected in the environment by external sensors.
Representation of trajectories: In one exemplary implementation, trajectories are represented as two-dimensional tensors, with the first variable-length dimension representing the time axis. The second dimension is of fixed length. In the reference implementation, trajectories in the second dimension have 14 entries, wherein the first 7 entries describe the pose of the TCP in world coordinates according to the above convention and the following 6 entries describe the forces and torques according to the above convention. The last entry is the probability of success p_{erfolg} of the movement, with p_{erfolg}∈[0, 1]. Furthermore, the space of the trajectories, in particular in the context of the exemplary embodiments, can be designated as y and a trajectory from this space as Y. The trajectory resulting from the execution of the i-th component of a robot program can be designated as Yᵢ and the n-th vector in the trajectory Yᵢ as (Yᵢ)ₙ.

Training of the learnable representatives as system models for the sub-process encapsulated in the associated component:
Training algorithm for differentiable component representatives: By implementing differentiable component representatives as neural networks, they become trainable. In the exemplary reference implementation according to one exemplary embodiment, these are trained to triples (xₜᵣₐᵢₙ, sₜᵣₐᵢₙ, Yₜᵣₐᵢₙ). xₜᵣₐᵢₙ is the parameter vector for the program component and contains both the constant and the component parameters that can be optimized. Yₜᵣₐᵢₙ is a sequence of vectors, each containing the absolute position and orientation of the TCP relative to the base coordinate system of the robot, forces and torques at the TCP in all Cartesian spatial directions, and the status code that encodes whether the component was executed successfully. sₜᵣₐᵢₙ is the measured system status at the start of execution of the component. The trajectory generator maps (xₜᵣₐᵢₙ, sₜᵣₐᵢₙ) to the prior trajectory Ŷ. The recurrent neural network maps (xₜᵣₐᵢₙ, Ŷ) to Yᵣₑₛ. The expected posterior trajectory Y_{pred} resulting from the addition of Yᵣₑₛ and Ŷ. The prediction of the position, orientation, force and torque components is treated as a joint learning problem and a joint loss value is calculated using a special loss function. This regression loss is the weighted sum of the mean square error of the position, force and torque components as well as the angular difference of the orientation component encoded in quaternions. The prediction of the status code is treated as a binary classification problem and evaluated by means of the binary cross-entropy. Regression and classification loss are combined by weighted addition and the weights of the neural network are learned using a gradient-based optimization algorithm. The selected representation of trajectories as well as the regression loss function for trajectories are particularly advantageous.
Implementation: For the implementation of the component representatives, in an exemplary reference implementation according to one exemplary embodiment a differentiable generator can be implemented for each supported component type. Since the representatives of different component types only differ structurally in the length of the parameter vector xᵢ, component representatives can be constructed generically from the associated generator and an untrained neural network. In the reference implementation, the Adam optimization algorithm is used for training the neural networks (cf. D. P. Kingma and J. Ba, “Adam: A Method for Stochastic Optimization,” ArXiv14126980 Cs, December 2014, Accessed: Aug. 12, 2019. [Online]. Available at: http://arxiv.org/abs/1412.6980; algorithm 1, page 2). Before each training step, the entries of xₜᵣₐᵢₙ, sₜᵣₐᵢₙ and Yₜᵣₐᵢₙ are scaled to the domain [−1, 1]. An exception is the p_{erfolg} entry of xₜᵣₐᵢₙ, because the binary cross-entropy loss function expects logs. For training the component representatives and subsequent parameter inference, both the label trajectories and the predicted trajectories are filled to a fixed length, since the recurrent components of the network architecture expect sequences of fixed length. To restore the original trajectory, a Boolean flag p_{padding} is added to the last dimension of the trajectory sensors, which indicates whether the data point belongs to the padding sequence or not. In order to learn the padding, the training algorithm is extended to include another classification problem, similar to the prediction of p_{erfolg}.

### Inference Phase:

Combination of the learned representatives into complete system models for each contiguous sequence of critical components:
Algorithm: Since program components are executed sequentially and the execution of previous components influences the execution of subsequent components, consecutive trained component representatives are combined to form a common calculation graph (cf. FIG. 9). Context information such as the current position and orientation of the TCP flows from one component to the next via the state vector s. The parameter vectors xᵢ for each component i are fed into the calculation graph as leaf nodes. The resulting expected posterior overall trajectory of the sub-program is the concatenation of the expected posterior partial trajectories of the constituent component representatives. Each processing step within a component representative is configured in such a way that the output can be differentiated with respect to the input, from which it follows that the entire component representative can be differentiated with respect to the input parameters. The end-to-end differentiability (ability to differentiate the output trajectories with respect to the input parameters) of the component representatives as well as the state vectors sᵢ ensure the end-to-end differentiability of the overall trajectory with respect to the parameter vectors. This differentiable representation of complex robot programs represents a significant innovation compared to the prior art.
Implementation: Specifically, a Python class hierarchy is instantiated, which maps the program structure and the leaves of which contain the differentiable component representatives trained in step 3. The root object (the program abstraction) keeps an ordered list of all representatives. The differentiable calculation graph is dynamically generated by the Autograd framework of PyTorch during the successive evaluation of the component representatives (cf. A. Paszke et al., “Automatic differentiation in PyTorch”, October 2017, Accessed: Aug. 12, 2019. [Online]. Available at: https://openreview.net/forum?id=BJJsrmfCZ). This reduces the calculation of the overall trajectory to the evaluation of the calculation graph. The state vectors sᵢ are calculated using only differentiable operations from the predicted sub-trajectories of the preceding components (Yᵢ₋₁). In the reference implementation, the calculation corresponds to the removal of the last pose from Yᵢ₋₁.

### Inference of Optimal Parameters:

Formulation of the optimization problem: The target function is an input into the optimization algorithm with the signature ϕ: [symbol] → [symbol] , and thus maps a trajectory to a real number. The goal of the optimization is to find the optimal parameterization x*, which also maximizes the target function φ_{P,ϕ}: [symbol] → [symbol] with φ_{P,ϕ}(x)=ϕ(P(x)), where [symbol] denotes the space of the program parameters and P the differentiable program representation. In order to simplify the implementation, the loss function [symbol] =−φ_{P,ϕ} and the corresponding minimization problem

$${x}^{*} = {arg min}_{x} ℒ ( x )$$

are considered instead of the target function φ.
Example: Loss function for the cycle time: A loss function for minimizing the cycle time can be defined as follows: [symbol] _{Zyklus}(Y)=Σᵢ₌₁^{N} (1−σ((Y_{i,p}_{_{padding}}−0.5)*T, where σ represents the sigmoid function, N the filled, fixed length of the trajectory, T (˜100) is a constant and Y_{i,padding} is the entry p_{padding} of the i-th vector of the trajectory tensor Y. [symbol] _{Zyklus} calculates the approximated unfilled length of the trajectory Y and can be differentiated. T determines the accuracy of the approximation.
Example: Loss function for the cycle time: A loss function to minimize the probability of program execution failure can be defined as follow:

$${ℒ}_{Fehler} ( Y ) = 1 - max ( 0 , min ( \frac{1}{N} {\sum }_{i = 1}^{N} {Y}_{i , {p}_{erfolg}} , 1 ) ) ,$$

where N represents the filled, fixed length of the trajectory and Y_{i,p}_{_{erfolg}} the entry p_{erfolg} of the i-th vector of the trajectory tensor Y. [symbol] _{Fehler} calculates the average probability that the execution of the robot program will fail, over all points of the trajectory.
Algorithm: The program parameters are optimized using a variant of Neural Network Iterative Inversion (NNII) or gradient descent in the input space (cf. D. A. Hoskins, J. N. Hwang, and J. Vagners, “Iterative inversion of neural networks and its application to adaptive control”, IEEE Trans. Neural Netw., Volume 3, No. 2, pp. 292-301, March 1992, doi: 10.1109/72.125870): firstly, the parameter vectors xᵢ in the calculation graph are initialized with an initial parameterization and the starting state so is initialized with the current state of the robot cell. In each step of the iterative optimization procedure, the expected overall trajectory is predicted by evaluating the calculation graph and the target function is evaluated. Using a gradient-based optimization method, the parameter vectors are adjusted incrementally in the direction of the gradient of the loss function, according to the following formula:

$$\begin{matrix}\frac{d ℒ}{d {x}_{t}} = \frac{d ℒ}{d ϕ} \frac{\partial ϕ}{\partial P} \frac{\partial P}{{x}_{t}} = - \frac{\partial ϕ}{\partial P} \frac{\partial P}{\partial {x}_{t}} \\ {x}_{t + 1} = {x}_{t} - \frac{λ d ℒ}{d {x}_{t}}\end{matrix}$$

The formula refers to a Neural Network Iterative Inversion (NNII) (gradient descent in the input space), where λ is the learning rate. The gradients of parameters labeled as constant are masked out in each optimization step. After a finite number of iterations (100<N<1000), the parameters converge to a local minimum. As with all optimization methods based on gradient descent, NNII is asymptotically optimal for a convex loss function, i.e. converges to a global minimum in an arbitrary number of iteration steps and at an arbitrarily small learning rate. In the actual application, the global convergence of NNII depends on the initial parameterization, due to local minima of the loss function. In practice, convergence can be guaranteed by using Monte Carlo methods (meta-optimization by repeated optimization based on randomly sampled initial parameter settings) or similar blackbox optimization methods, with additional expenditure of computing time. In addition, the initial parameterization, i.e. that originally specified by the robot programmer, is in many cases already located in a locally convex region of the target function around the global optimum. The use of NNII (gradient descent in the input space) for the inference of optimal robot program parameters represents a significant improvement.
Implementation. The PyTorch implementation of the Adam optimization algorithm is used to solve the minimization problem. This is initialized with the parameters of the component representatives of the sub-program currently under consideration that are declared as optimizable (not constant). Reference is made to the following pseudocode for the Neural Network Iterative Inversion (NNII) procedure:
   optimizable_params=
   [(neural_template.optimizable_parameters( ))
      for neural_template in neural_program]
   optimizer=Adam(optimizable_params, lr=0.005)
   for i in range (n iterations):
      trajectory=neural_program.forward( )
      loss=loss_fn(trajectory)
      backpropagate(neural_program, loss)
      optimizer.update_parameters( )

The increment (lr or λ) is a globally adjustable hyperparameter of the optimization algorithm, the choice of which depends on the application domain, limitations in the computation time for the optimization, and the desired convergence properties of the optimization method. For large values of λ, Adam converges faster, but with unfavorable combinations of target functions it can oscillate. For small values of λ, Adam converges more slowly, but oscillates much less and terminates closer to the global optimum. Depending on the nature of the procedure, the Adam optimization algorithm can be supplemented by mechanisms such as weight decay or learning rate scheduling, to dynamically balance convergence and runtime. The Autograd library of PyTorch is used to calculate the gradients (backpropagate). Apart from the optimizable input parameters of the components (optimizable_params), all other parameters (constant component parameters, but also the weights of the neural networks within the component representatives) remain constant.

FIG. 10 shows a recurrent network architecture for one exemplary embodiment of the invention. The length s of the state vector and the length x of the parameter vector can be set or are component-dependent. The sequence length here is set to 500. The batch dimension has been omitted for convenience.

The network maps inputs (left) to outputs (right).

Inputs:
The prior trajectory (output of the trajectory generator), a tensor of dimension (500, 13) (a 500×13 matrix, i.e. 500 vectors of length 13)
The current state, a vector of length p, depending on how the state is encoded as a vector. In an exemplary implementation, the length of the state vector depends on the component; some components may require additional information such as the current gripper opening, etc. that other components do not require.
The vector of the input parameters with length x (the length depends on the component because the components have different parameters)

Outputs:
The residual trajectory, a tensor of dimension (500, 13). In FIG. 8, this is Ŷ_{res,i}. This residual, added to the prior trajectory, gives the posterior trajectory Ŷᵢ.
p_{padding}: a tensor of dimension (500, 1) that indicates for each time step of the trajectory whether the time step belongs to the padding or not (contains values between 0 and 1).
p_{erfolg}: a tensor of dimension (500, 1) that specifies for each time step of the trajectory the probability of success of the component at this time (contains values between 0 and 1).

From left to right, the following function is performed:
First, the state and input vector are converted by repetition into tensors of dimensions (500, p) and (500, x).
The resulting tensor is mapped to a tensor of dimension (500, 256) by a fully connected network layer (FCN).
This is followed by 4 Gated Recurrent Units (GRU), recurrent network layers, each producing output tensors of dimension (500, 256). For a theoretical consideration of GRUs, see K. Cho, et al., “Learning Phrase Representations using RNN Encoder-Decoder for Statistical Machine Translation,” in EMNLP, Doha, Qatar, October 2014, pp. 1724-1734, doi: 10.3115/v1/D14-1179. For a practical implementation, see the PyTorch implementation of GRUs at https://pytorch.org/docs/master/generated/torch.nn.GRU.html. The GRUs are “residual” (this has nothing to do with the residual trajectory Ŷ_{res,i}), i.e. the outputs of a GRU are not only inputs for the following GRU, but also the one after that. This is indicated in FIG. 10 by the thin arrows and the dashed tensors.
The output of the last GRU is converted into the residual trajectory by a final fully connected layer, p_{padding} and p_{erfolg}.
Each layer is followed by a downstream activation function, but for the sake of simplicity this is not shown in FIG. 10. Scaled Exponential Linear Units (SELU) are used here. For a theoretical consideration of SELUs, see G. Klambauer, T. Unterthiner, A. Mayr, and S. Hochreiter, “Self-Normalizing Neural Networks,” in NeurIPS, I. Guyon, U. V. Luxburg, S. Bengio, H. Wallach, R. Fergus, S. Vishwanathan, and R. Garnett, published 2017, pp. 971-980. For a practical implementation, see the PyTorch implementation of GRUs at https://pytorch.org/docs/master/generated/torch.nn.SELU.html.

The training is particularly effective when the network is trained on batches of training data in parallel on a graphics card (GPU). The batch dimension has been omitted in FIG. 10 for simplification purposes. For example, according to a reference implementation according to an exemplary embodiment, batches of size 64 can be used.

With regard to further advantageous configurations of the method according to the invention and the system according to the invention, reference is made to the general part of the description and to the attached claims in order to avoid repetition.

Finally, it should be expressly pointed out that the above described exemplary embodiments of the method according to the invention and the system according to the invention serve only to elucidate the claimed teaching, but do not restrict it to the exemplary embodiments.

### LIST OF REFERENCE NUMERALS

1 semi-symbolic robot program
2 critical sub-program
3 critical program component
4 critical program component
5 semi-symbolic robot program
6 critical sub-program
7 critical program component
8 critical program component
9 robot cell
10 programming system
11 database
12 learning system
13 ontology
14 system for specifying target functions
15 inference system

1. A method for determining optimized program parameters for a robot program, wherein the robot program is used to control a robot having a manipulator, comprising the steps:
generating the robot program by means of a component-based graphical programming system on the basis of user inputs, wherein the robot program is formed from program components which are parameterizable via program parameters, and wherein initial program parameters are generated for the program components of the robot program;
providing an interface for selecting one or more critical program components, wherein optimizable program parameters can be defined for the critical program components;
carrying out an exploration phase for exploring a parameter space in relation to the optimizable program parameters, the robot program being executed multiple times, the parameter space being sampled for the critical program components and trajectories of the robot being recorded such that training data are available for the critical program components;
carrying out a learning phase in order to generate component representatives for the critical program components of the robot program on the basis of the training data collected in the exploration phase, wherein a component representative represents a system model which, in the form of a differentiable function, maps a specified state of the robot and specified program parameters to a predicted trajectory;
carrying out an inference phase for determining optimized program parameters for the critical program components of the robot program, wherein optimizable program parameters of the component representatives are iteratively optimized with respect to a specified target function by means of a gradient-based optimization method using the component representatives.

2. The method according to claim 1, wherein parameter domains are defined for the optimizable program parameters, wherein the optimizable program parameters are optimized via the parameter domains.

3. The method according to claim 1, wherein the parameter domains for the optimizable program parameters are at least one of specified, able to be specified or able to be set.

4. The method according to claim 1, wherein in the exploration phase for sampling the parameter space, the optimizable program parameters are sampled from their respective parameter domain.

5. The method according to claim 1, wherein the robot program is stored in a serialized form in a format that allows reconstruction and parameterization of the robot program or its program components.

6. The method according to claim 1, wherein for an execution of the robot program, a sampled trajectory is stored in such a way that an associated program component and a parameterization of the associated program component can be uniquely assigned to each data point of the trajectory at the time of the respective execution.

7. The method according to claim 1, wherein in the exploration phase the robot program is executed automatically, wherein at least 100 executions or at least 1000 executions of the robot program are carried out to extract the training data.

8. The method according to claim 1, wherein the training data collected in the exploration phase for each execution of the robot program comprises a parameterization of the critical program components, and a sampled trajectory of the critical program components.

9. The method according to claim 1, wherein the training data collected in the exploration phase for each executed program component comprises at least one of an ID or a status code.

10. The method according to claim 1, wherein in the learning phase for the critical program components, learnable component representatives are first generated, wherein the learnable component representatives are trained with the training data of the exploration phase in order then to represent system models for sub-processes encapsulated in the associated critical program components as component representatives.

11. The method according to claim 1, wherein the component representatives comprise a recurrent neural network

12. The method that wherein to generate the component representatives an analytical trajectory generator is placed upstream of the recurrent neural network, the analytical trajectory generator being designed to generate a prior trajectory.

13. The method according to claim 1, wherein the target function is defined in such a way that the target function maps a trajectory to a rational number and that the target function is differentiable with respect to the trajectory.

14. The method according to claim 1, wherein the target function comprises at least one of a predefined function, a parametric function, or a neural network.

15. The method according to claim 1, wherein the target function comprises a function based on a force measurement.

16. The method according to claim 1, wherein with the interface a critical sub-sequence of the robot program can be selected, wherein the critical sub-sequence comprises a plurality of critical program components, wherein the component representatives of the plurality of critical program components are combined into a differentiable overall system model that maps the program parameters of the critical sub-sequence to a combined trajectory, so that the optimizable program parameters are optimized with respect to the target function for a contiguous sub-sequence of critical program components.

17. A system for determining optimized program parameters for a robot program, wherein the robot program is used to control a robot having a manipulator, comprising:
a component-based graphical programming system for generating a robot program on the basis of user inputs, wherein the robot program is formed from program components which are parameterizable via program parameters, and wherein initial program parameters can be generated for the program components of the robot program;
an interface for selecting one or more critical program components, wherein optimizable program parameters can be defined for the critical program components;
an exploration module for exploring a parameter space in relation to the optimizable program parameters, the robot program being executed multiple times, the parameter space being sampled for the critical program components and trajectories of the robot being recorded such that training data are available for the critical program components;
a learning module for generating component representatives for the critical program components of the robot program on the basis of the training data collected in the exploration phase, wherein a component representative represents a system model which, in the form of a differentiable function, maps a specified state of the robot and specified program parameters to a predicted trajectory;
an inference module for determining optimized program parameters for the critical program components of the robot program, wherein optimizable program parameters of the component representatives are iteratively optimized with respect to a specified target function by means of a gradient-based optimization method using the component representatives.

18. The method according to claim 4, wherein the optimizable program parameters are sampled in a uniformly distributed manner or adaptively sampled.

19. The method according to claim 5, wherein the format comprises at least one of a sequential execution sequence of the program components, types of program components, IDs of the program components, constant program parameters or program parameters that can be optimized.

20. The method according to claim 1, wherein the robot program is used to control the robot having the manipulator in a robot cell.
